(19) United States
(12) Patent Application Publication
(10) Pub. No.: US 2025/0167331 A1
(43) Pub. Date: May 22, 2025

(54) BATTERY TEMPERATURE CONTROL SYSTEM, BATTERY TEMPERATURE CONTROL METHOD, AND NON-TRANSITORY COMPUTER-READABLE RECORDING MEDIUM

(71) Applicant: Panasonic Intellectual Property Management Co., Ltd., Osaka (JP)

(72) Inventors: Makoto HASHIMOTO, Kyoto (JP); Changhui YANG, Osaka (JP); Masaharu AMAIKE, Kanagawa (JP)

(21) Appl. No.: 18/841,127

(22) PCT Filed: Dec. 22, 2022
(86) PCT No.: PCT/JP2022/047368

§ 371 Date: Aug. 23, 2024

(30) Foreign Application Priority Data
Feb. 25, 2022 (JP) 2022-028252

(51) Int. Cl. H01M 10/613; B60L 7/24; H01M 10/44; H01M 10/48; H01M 10/625; H01M 10/633

(52) U.S. Cl. CPC H01M 10/613; B60L 7/24; H01M 10/443; H01M 10/486; H01M 10/625; H01M 10/633; B60L 2240/545; B60L 2240/62; B60L 2260/56

(57) ABSTRACT

A battery temperature acquirer acquires a measured battery temperature of a battery module in a battery pack installed in an electric vehicle. A target temperature determination unit determines a target temperature of the battery module at the time of arrival at an installation place of a charger to which the electric vehicle is to head. A set value determination unit determines a combination of a set value for regenerative charging, a set value for output suppression, and a set value for a temperature adjustment unit such that the battery temperature becomes closer to the target temperature.

### CROSS-REFERENCE TO RELATED APPLICATIONS

This application is based upon and claims the benefit of priority from the prior Japanese Patent Application No. 2022-028252, filed on Feb. 25, 2022, and the International Patent Application No. PCT/JP2022/047368, filed on Dec. 22, 2022, the entire content of each of which is incorporated herein by reference.

### BACKGROUND

### Field of the Invention

The present disclosure relates to a battery temperature control system, a battery temperature control method, and a battery temperature control program for controlling the temperature of a battery installed in an electric vehicle.

### Description of the Related Art

In recent years, electric vehicles (EVs) and plug-in hybrid vehicles (PHVs) have been in widespread use. For these electric vehicles, efficient charging of on-board batteries and suppression of battery degradation is required. The load on the battery during charging depends also on the temperature. The battery temperature during charging is desirably about 0 to 40 degrees C., and, if a battery is charged in an environment exceeding 40 degrees C., the capacity may degrade quickly or the battery may swell greatly.

In this way, since charging at high battery temperatures causes negative effects on degradation, when the battery temperature is high, the measure of prohibiting charging or reducing the charge rate is generally taken. Therefore, when a person arrives at a charging station, if the battery temperature is high, the person cannot charge the battery immediately and must wait until the battery temperature drops, or the person needs to charge the battery at a lower charge rate, which in either case takes a longer time. In the case of a delivery vehicle, this leads to an increase in transportation time. In the case of personal use, it leads to a decrease in convenience.

If the number of times of charging at a high battery temperature increases, battery degradation will be accelerated. Also, if fast charging after the battery temperature drops is frequently performed, it will also cause acceleration of battery degradation. If battery degradation is accelerated, the battery replacement time will come earlier, which will increase the cost.

With regard to battery temperature control, a method has been proposed in which the battery temperature at the time of arrival at a charging station is predicted, a first charging time during which temperature control is not performed and a second charging time during which temperature control is performed are predicted, and, when the predicted temperature falls outside a reference range and also when the second charging time is shorter than the first charging time, temperature control is performed so that the temperature falls within the reference range (see Patent Literature 1, for example). Also, another method has been proposed in which whether or not a destination is a charging-available place is judged and, when the destination is a charging-available place, temperature control is performed so that the battery temperature becomes a charging-efficient temperature at the time of arrival at the destination (see Patent Literature 2, for example).

Patent Literature 1: Japanese Unexamined Patent Application Publication No. 2016-220310

Patent Literature 2: Japanese Patent No. 4228086

When the battery temperature is lowered using an electric fan or the like, the battery capacity is reduced due to the power consumption by the electric fan or the like. The reduction in battery capacity leads to a decrease in driving range.

### SUMMARY OF THE INVENTION

The present disclosure has been made in view of such a situation, and a purpose thereof is to provide a technology for efficiently adjusting the battery temperature to a target temperature before the start of charging.

To solve the problems above, a battery temperature control system according to one embodiment of the present disclosure includes: a battery temperature acquirer that acquires a measured battery temperature of a battery module in a battery pack installed in an electric vehicle, in which the battery pack includes the battery module, a temperature adjustment unit that adjusts the temperature of the battery module, and a battery control unit that outputs a set value for regenerative charging and a set value for output suppression to a vehicle control unit that controls an inverter connected between the battery module and a motor for driving; a target temperature determination unit that determines a target temperature of the battery module at the time of arrival at an installation place of a charger to which the electric vehicle is to head; and a set value determination unit that determines a combination of a set value for the regenerative charging, a set value for the output suppression, and a set value for the temperature adjustment unit such that the battery temperature becomes closer to the target temperature.

Optional combinations of the aforementioned constituting elements, and implementation of the present disclosure in the form of apparatuses, systems, methods, computer programs, and the like may also be practiced as additional modes of the present disclosure.

Embodiments will now be described, by way of example only, with reference to the accompanying drawings which are meant to be exemplary, not limiting, and wherein like elements are numbered alike in several Figures, in which:

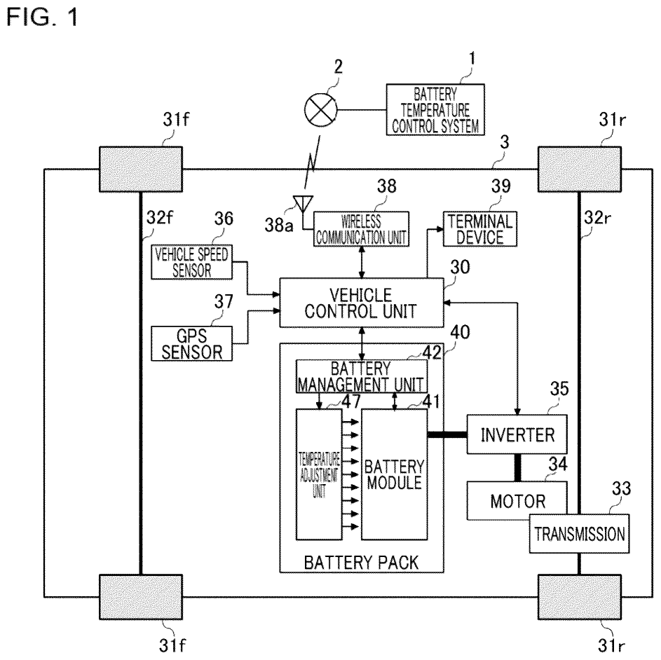

FIG. 1 is a diagram that shows a schematic configuration of an electric vehicle according to an embodiment.

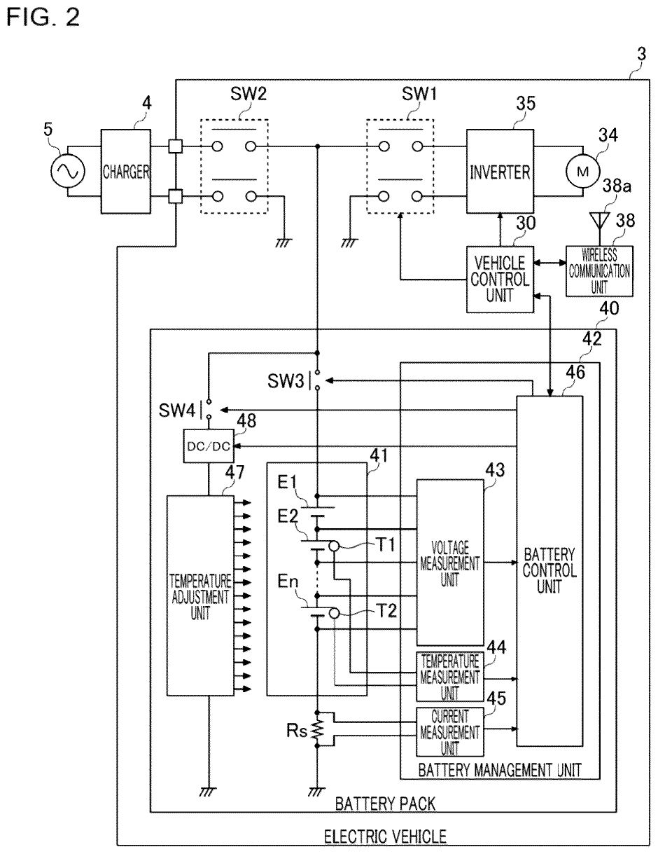

FIG. 2 is a diagram used to describe a detailed configuration of a battery pack of the electric vehicle shown in FIG. 1.

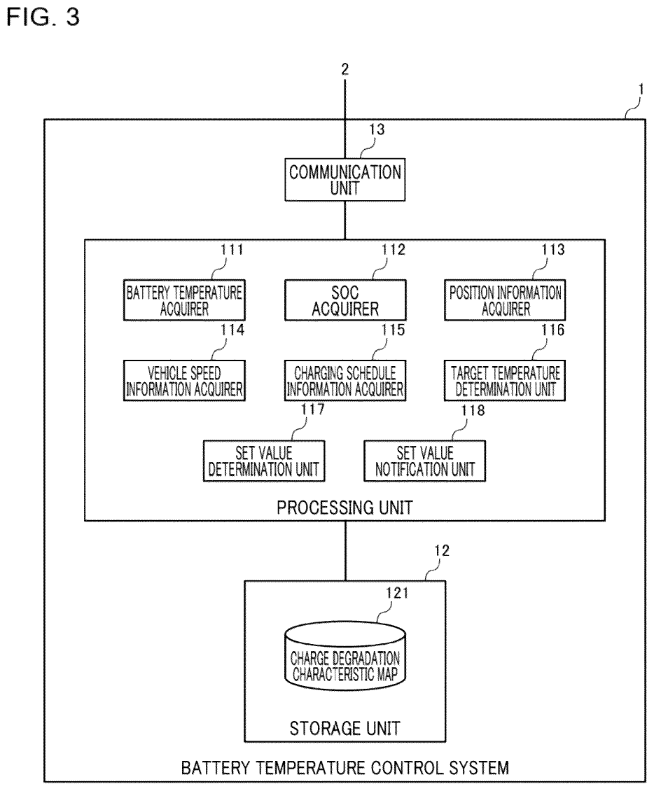

FIG. 3 is a diagram that shows an illustrative configuration of a battery temperature control system according to the embodiment.

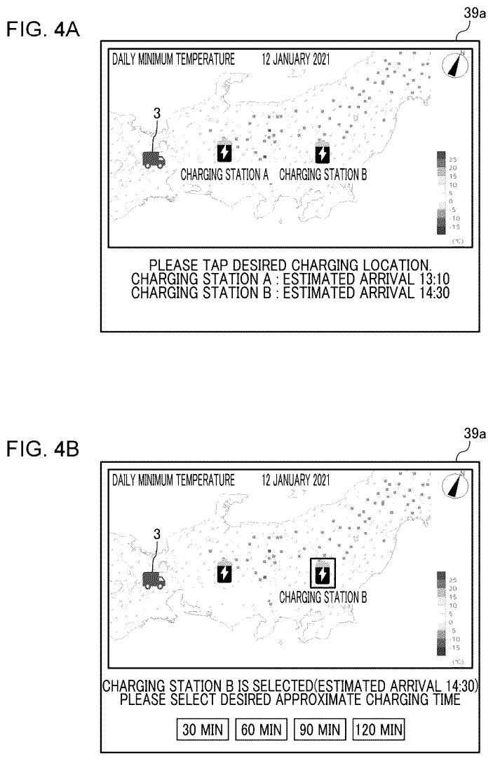

FIGS. 4A-4B are diagrams that each show an example of a GUI (Graphical User Interface) used to set a charging location and a charging time.

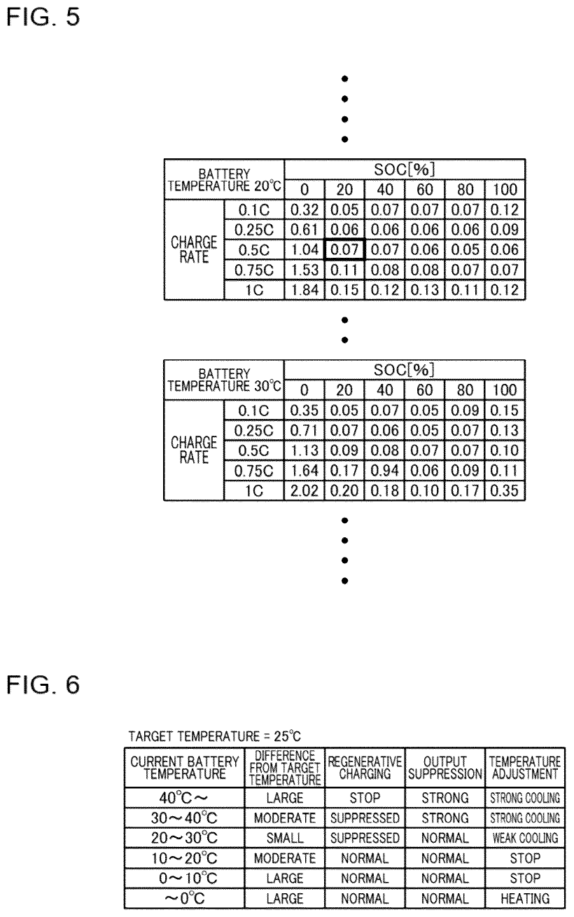

FIG. 5 is a diagram that shows a specific example of a charge degradation characteristic map.

FIG. 6 is a diagram that shows a specific example of a control map that defines control patterns for regenerative charging, output suppression, and a temperature adjustment unit, at the time of departure.

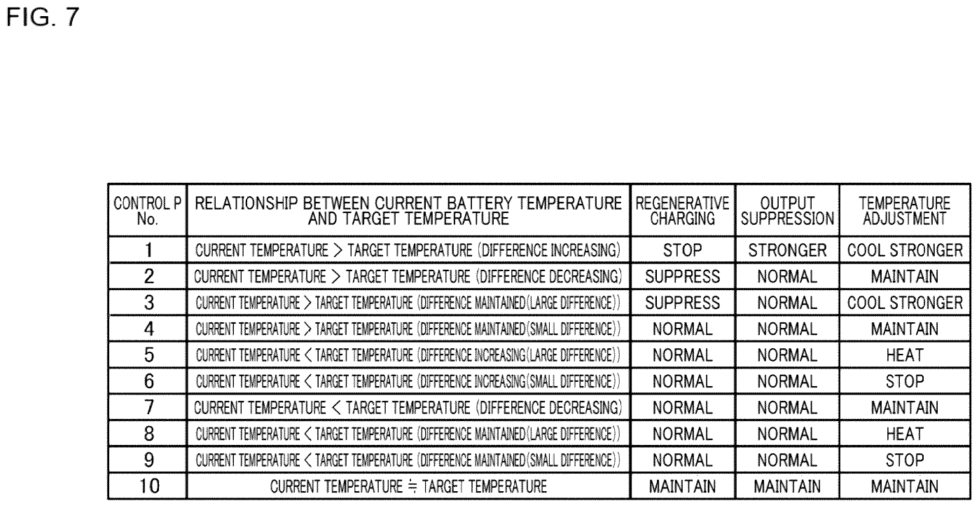

FIG. 7 is a diagram that shows a specific example of a control map that defines control patterns for the regenerative charging, output suppression, and temperature adjustment unit, during driving.

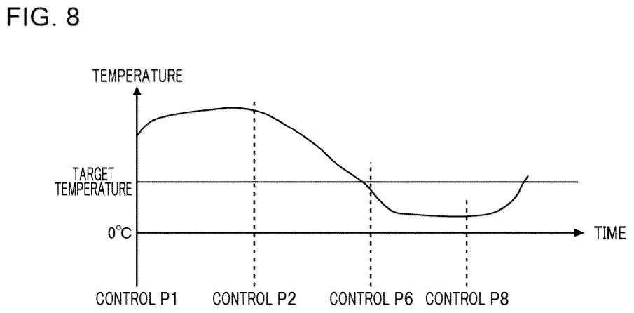

FIG. 8 is a diagram that shows a specific example of control pattern switching during driving.

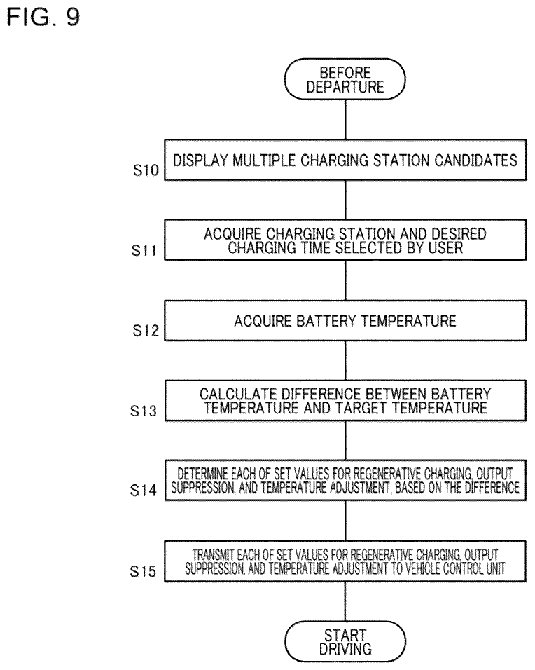

FIG. 9 is a flowchart that shows an outline of setting processing for the regenerative charging, output suppression, and temperature adjustment unit before departure.

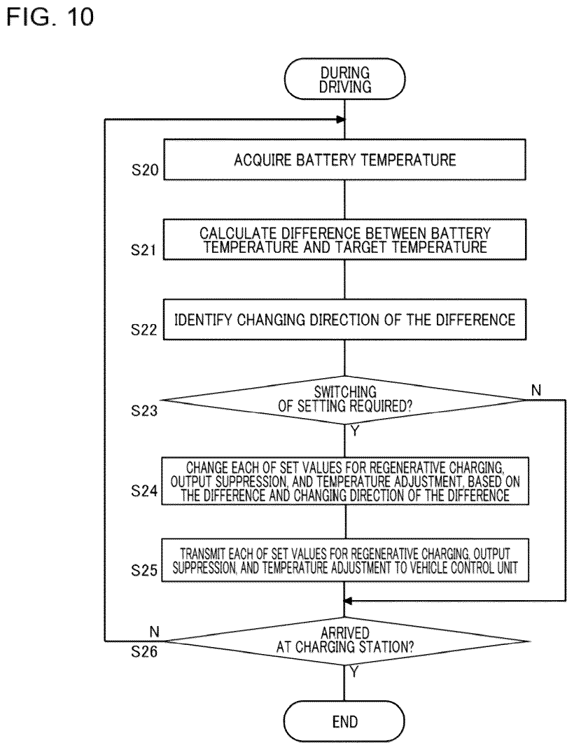

FIG. 10 is a flowchart that shows an outline of setting processing for the regenerative charging, output suppression, and temperature adjustment unit during driving.

### DETAILED DESCRIPTION OF THE INVENTION

The invention will now be described by reference to the preferred embodiments. This does not intend to limit the scope of the present invention, but to exemplify the invention.

FIG. 1 is a diagram that shows a schematic configuration of an electric vehicle 3 according to the embodiment. In the present embodiment, the electric vehicle 3 is assumed to be a simple EV that is not equipped with an internal-combustion engine. The electric vehicle 3 shown in FIG. 1 is a rear-wheel drive (2WD) EV that includes a pair of front wheels 31f, a pair of rear wheels 31r, and a motor 34 as a power source. The pair of front wheels 31f are connected by a front wheel axle 32f, and the pair of rear wheels 31r are connected by a rear wheel axle 32r. A transmission 33 transmits the rotation of the motor 34 to the rear wheel axle 32r at a predetermined conversion ratio. The electric vehicle 3 may be a front-wheel drive (2WD) or 4WD electric vehicle.

A battery pack 40 includes a battery module 41, a battery management unit 42, and a temperature adjustment unit 47. The battery management unit 42 monitors and measures the voltages, current, temperatures, and SOC (State Of Charge) of multiple cells included in the battery module 41 and transmits them as battery data to a vehicle control unit 30 via an on-board network. As the on-board network, the CAN (Controller Area Network) or LIN (Local Interconnect Network) may be used, for example.

The temperature adjustment unit 47 adjusts the temperature of the battery module 41. The temperature adjustment unit 47 includes a cooling system for cooling the battery module 41, and a heating system for heating the battery module 41. For example, a liquid-cooled cooling system is configured to include: a flow path for flowing a refrigerant (e.g., water or coolant liquid) provided near the multiple cells; heat dissipation fins, an electric fan, or an air conditioner for cooling the refrigerant; and an electric pump for circulating the refrigerant. In the case of the air-cooled type, cooling air is used instead of the refrigerant.

The heating system is configured, for example, by an electric heating sheet with a built-in electric wire heater, which is attached to the surfaces of the multiple cells. Also, the heating system may be configured to include a flow path for flowing a heat medium (e.g., heated water) provided near the multiple cells, a heater for heating the heat medium, and an electric pump for circulating the heat medium. The heating system is provided because, when lithium-ion batteries are charged and discharged at low temperatures, dendritic crystals deposit on the electrode plates, causing degradation and malfunction. The heating system may be omitted depending on where the battery pack 40 is delivered. The temperature adjustment unit 47 may be provided outside the battery pack 40. For example, the battery module 41 may be air-cooled by a cooling fan installed outside the battery pack 40.

In an EV, a three-phase AC motor is generally used for the motor 34 for driving. An inverter 35 converts DC electricity supplied from the battery module 41 into AC electricity and supplies it to the motor 34 during powered operation. During regenerative operation, AC electricity supplied from the motor 34 is converted into DC electricity and supplied to the battery module 41. The motor 34 rotates by means of the AC electricity supplied from the inverter 35 during powered operation. During regenerative operation, rotational energy due to deceleration is converted into AC electricity and supplied to the inverter 35.

The vehicle control unit 30 is a vehicle ECU (Electronic Control Unit) that controls the entire electric vehicle 3 and may be constituted by an integrated VCM (Vehicle Control Module), for example. To the vehicle control unit 30, various detection information that indicates the state of the electric vehicle 3 is input from various sensors in the electric vehicle 3. As the various sensors, a vehicle speed sensor 36 and a GPS (Global Positioning System) sensor 37 are provided in FIG. 1.

The vehicle speed sensor 36 generates a pulse signal proportional to the rotational frequency of the front wheel axle 32f or the rear wheel axle 32r and transmits the pulse signal thus generated to the vehicle control unit 30. Based on the pulse signal received from the vehicle speed sensor 36, the vehicle control unit 30 detects the speed of the electric vehicle 3.

The GPS sensor 37 detects position information of the electric vehicle 3 and transmits the position information thus detected to the vehicle control unit 30. In specific, the GPS sensor 37 receives radio waves including the transmission times thereof from multiple GPS satellites and calculates the latitude and longitude of the reception point based on the multiple transmission times included in the respective multiple radio waves thus received. The GPS sensor 37 may be a GPS sensor built into a terminal device 39.

A wireless communication unit 38 includes a modem and performs signal processing for wireless connection to a network 2 via an antenna 38a. As a wireless communication network to which the electric vehicle 3 can wirelessly connect, a cellular phone network (cellular network), a wireless LAN, a V2I (Vehicle-to-Infrastructure), a V2V (Vehicle-to-Vehicle), an ETC system (Electronic Toll Collection System), or DSRC (Dedicated Short Range Communications) can be used, for example.

The terminal device 39 is a user-operable terminal device provided with a display and an operation unit and may be fixed to the electric vehicle 3 or may be detachable. The terminal device 39 may be a car navigation system or may be a smartphone or tablet on which a car navigation application program is installed.

The terminal device 39 searches for a route from the current position detected by the GPS sensor 37 to a destination input by the user of the electric vehicle 3, with reference to digital road map data. The terminal device 39 provides route guidance based on the route selected by the user.

While the electric vehicle 3 is stopped or driving, the vehicle control unit 30 can communicate with the battery temperature control system 1 connected to the network 2, using the wireless communication unit 38.

FIG. 2 is a diagram used to describe a detailed configuration of the battery pack 40 of the electric vehicle 3 shown in FIG. 1. The battery pack 40 is connected to the motor 34 via a first switch SW1 and the inverter 35. The first switch SW1 is a contactor inserted in a wire connecting the battery pack 40 and the inverter 35. During driving, the vehicle control unit 30 controls the first switch SW1 to place it in an ON state (a closed state) and electrically connects the battery pack 40 and the power system of the electric vehicle 3. When not driving, the vehicle control unit 30 controls the first switch SW1 to place it in an OFF state (an open state) in principle and electrically disconnects the battery pack 40 and the power system of the electric vehicle 3.

By connecting the electric vehicle 3 to a charger 4, the electric vehicle 3 can be charged externally. The charger 4 is connected to a commercial power system 5 and charges the battery module 41 in the electric vehicle 3. In the electric vehicle 3, a second switch SW2 is inserted in a wire connecting the battery pack 40 and the charger 4. The battery management unit 42 controls, via the vehicle control unit 30 or directly, the second switch SW2 to place it in an ON state before the start of charging and also controls the second switch SW2 to place it in an OFF state after the completion of charging.

In general, batteries are charged with AC for normal charging, and with DC for fast charging. In the case of charging with AC (e.g., single-phase 100/200 V), the AC electricity is converted into DC electricity by an AC/DC converter (not illustrated) inserted between the second switch SW2 and the battery module 41. In the case of charging with DC, the charger 4 performs full-wave rectification of AC electricity supplied from the commercial power system 5 and smooths it with a filter to generate DC electricity.

As the fast charging standard, CHAdeMO (registered trademark), ChaoJi, GB/T, or Combo (Combined Charging System) can be used, for example. In CHAdeMO, ChaoJi, and GB/T, CAN is employed as the communication scheme. In Combo, PLC (Power Line Communication) is employed as the communication scheme.

In a charging cable that employs the CAN system, communication lines are also included in addition to power lines. When the electric vehicle 3 and the charger 4 are connected by this charging cable, the vehicle control unit 30 establishes a communication channel with the control unit of the charger 4. Meanwhile, in a charging cable employing the PLC system, communication signals are superimposed on the power lines and transmitted. The vehicle control unit 30 establishes a communication channel with the battery control unit 46 via the on-board network. When the communication standard between the vehicle control unit 30 and the control unit of the charger 4 is different from the communication standard between the vehicle control unit 30 and the battery control unit 46, the vehicle control unit 30 performs a gateway function.

Between the connection point of the first switch SW1 and the second switch SW2 and the battery module 41, a third switch SW3 is inserted. Also, between the connection point of the first switch SW1 and the second switch SW2 and a DC/DC converter 48, a fourth switch SW4 is inserted. For each of the first switch SW1 to the fourth switch SW4, a relay may be used, or a semiconductor switch may also be used.

The battery module 41 includes multiple cells E1 to En connected in series. The configuration may also be provided such that multiple parallel cell blocks, which each are configured by multiple cells connected in parallel, are connected in series. For the cells, lithium-ion battery cells, nickel-metal hydride battery cells, and the like may be used. In the following, as an example, it will be assumed in the present specification that lithium-ion battery cells (nominal voltage: 3.6 to 3.7 V) are used. The number of cells E1 to En connected in series is determined based on the drive voltage of the motor 34.

A shunt resistor Rs is connected in series with the multiple cells E1 to En. The shunt resistor Rs functions as a current sensing element. Instead of the shunt resistor Rs, a Hall element may be used. In the battery module 41, multiple temperature sensors T1 and T2 are provided to detect temperatures of the multiple cells E1 to En. For the temperature sensors T1 and T2, thermistors may be used, for example. One temperature sensor may be provided, for example, for six to eight cells.

The battery management unit 42 includes a voltage measurement unit 43, a temperature measurement unit 44, a current measurement unit 45, and the battery control unit 46. The nodes of the multiple cells E1 to En connected in series are connected with the voltage measurement unit 43 respectively by multiple voltage lines. The voltage measurement unit 43 measures the voltage between each two adjacent voltage lines, so as to measure the voltage of each of the cells E1 to En. The voltage measurement unit 43 transmits the voltage of each of the cells E1 to En thus measured to the battery control unit 46.

Since the voltage measurement unit 43 has a higher voltage with respect to the battery control unit 46, the voltage measurement unit 43 and the battery control unit 46 are connected in an insulated state by a communication line. The voltage measurement unit 43 may be constituted by an ASIC (Application Specific Integrated Circuit) or a general-purpose analog front-end IC. The voltage measurement unit 43 includes a multiplexer and an A/D converter. The multiplexer outputs, to the A/D converter, the voltages between two adjacent voltage lines in order from the top. The A/D converter converts the analog voltages input from the multiplexer into digital values.

The temperature measurement unit 44 includes voltage dividing resistors and an A/D converter. The A/D converter sequentially converts, into digital values, multiple analog voltages divided by means of the multiple temperature sensors T1 and T2 and multiple voltage dividing resistors and outputs the digital values to the battery control unit 46. Based on the digital values, the battery control unit 46 estimates the temperatures of the multiple cells E1 to En. For example, the battery control unit 46 estimates the temperature of each of the cells E1 to En based on a value measured by the temperature sensor most adjacent to the cell.

The current measurement unit 45 includes a differential amplifier and an A/D converter. The differential amplifier amplifies the voltage between both ends of the shunt resistor Rs and outputs it to the A/D converter. The A/D converter converts the analog voltage input from the differential amplifier into a digital value and outputs it to the battery control unit 46. Based on the digital value, the battery control unit 46 estimates the current flowing through the multiple cells E1 to En.

When an A/D converter is provided within the battery control unit 46 and an analog input port is also provided in the battery control unit 46, the temperature measurement unit 44 and the current measurement unit 45 may output the analog voltages to the battery control unit 46, and the analog voltages may be converted into digital values by means of the A/D converter within the battery control unit 46.

Based on the voltages, temperatures, and current of the multiple cells E1 to En measured by the voltage measurement unit 43, the temperature measurement unit 44, and the current measurement unit 45, the battery control unit 46 manages the states of the multiple cells E1 to En. If overvoltage, undervoltage, overcurrent, or a temperature abnormality occurs in at least one of the multiple cells E1 to En, the battery control unit 46 will turn off the third switch SW3 to protect the cell.

The battery control unit 46 can be constituted by a microcontroller and a non-volatile memory {e.g., an EEPROM (Electrically Erasable Programmable Read-Only Memory) or a flash memory}.

The battery control unit 46 estimates the SOC of each of the multiple cells E1 to En. The battery control unit 46 estimates the SOC by combining the OCV (Open Circuit Voltage) method and the current integration method. The OCV method is a method of estimating the SOC based on the OCV of each cell measured by the voltage measurement unit 43 and the SOC-OCV curve of the cell. The SOC-OCV curve of the cell is created in advance based on characteristic tests performed by the battery manufacturer and is registered in the internal memory of the microcontroller at the time of shipment.

The current integration method is a method of estimating the SOC based on the OCV at the start of charging or discharging of each cell and the integrated value of the current measured by the current measurement unit 45. In the current integration method, the measurement errors of the current measurement unit 45 accumulate as the charging and discharging time increases. Meanwhile, the OCV method is affected by the measurement errors of the voltage measurement unit 43 and an error due to a polarization voltage. Therefore, it is preferable to use a weighted average of the SOC estimated by the current integration method and the SOC estimated by the OCV method.

The battery control unit 46 periodically (e.g., at intervals of 10 seconds) samples the battery data including the voltage, current, temperature, and SOC of each of the cells E1 to En or parallel cell blocks. The battery control unit 46 transmits at least a temperature and SOC of the battery module 41 to the vehicle control unit 30 via the on-board network. For example, the battery control unit 46 transmits, as battery temperatures, an average temperature, the maximum temperature, and the minimum temperature of multiple temperatures detected by the multiple temperature sensors provided in the battery module 41, to the vehicle control unit 30. Based on the SOC of each of the cells E1 to En or parallel cell blocks, the battery control unit 46 calculates the SOC of the battery module 41 and transmits the SOC of the battery module 41 thus calculated to the vehicle control unit 30 via the on-board network.

The vehicle control unit 30 can transmit, to the battery temperature control system 1 in real time using the wireless communication unit 38, the battery temperatures and SOC received from the battery control unit 46, the position information (latitude and longitude) of the electric vehicle 3 acquired from the GPS sensor 37, vehicle speed information acquired from the vehicle speed sensor 36, or the user's operation information input to the terminal device 39. When a wireless communication unit is built into the terminal device 39, the user's operation information input to the terminal device 39 may be transmitted from the wireless communication unit of the terminal device 39 to the battery temperature control system 1.

The DC/DC converter 48 can step down the voltage of the DC electricity supplied from the battery module 41 via the third switch SW3 and the fourth switch SW4, or the voltage of the regenerated DC electricity from the inverter 35 via the first switch SW1. The DC/DC converter 48 controls the voltage, current, or electricity supplied to the temperature adjustment unit 47 by controlling the duty ratio, phase difference, or frequency of an internal switching element according to a voltage command value, a current command value, or an electricity command value set by the battery control unit 46.

The battery control unit 46 can control the cooling intensity or heating intensity of the temperature adjustment unit 47. When increasing the cooling intensity of the temperature adjustment unit 47, the battery control unit 46 performs at least one of: increasing the flow rate of the refrigerant or cooling air delivered from the electric pump; or increasing the rotational frequency of the electric fan (or lowering the set temperature of the air conditioner) used to cool the refrigerant or cooling air. When decreasing the cooling intensity of the temperature adjustment unit 47, the battery control unit 46 performs at least one of: decreasing the flow rate of the refrigerant or cooling air delivered from the electric pump; or decreasing the rotational frequency of the electric fan (or raising the set temperature of the air conditioner) used to cool the refrigerant or cooling air.

When increasing the heating intensity of the temperature adjustment unit 47, the battery control unit 46 increases the amount of current supplied to the electric wire heater. Alternatively, the battery control unit 46 performs at least one of: increasing the flow rate of the heat medium delivered from the electric pump; or raising the set temperature of the heater used to heat the heat medium. When decreasing the heating intensity of the temperature adjustment unit 47, the battery control unit 46 decreases the amount of current supplied to the electric wire heater. Alternatively, the battery control unit 46 performs at least one of: decreasing the flow rate of the heat medium delivered from the electric pump; or lowering the set temperature of the heater used to heat the heat medium.

The battery control unit 46 can instruct the vehicle control unit 30 to suppress the output, via the on-board network. In specific, the battery control unit 46 sets an upper limit current value of the current supplied from the inverter 35 to the motor 34. The battery control unit 46 changes the upper limit current value to a lower value when increasing the intensity of the output suppression and changes the upper limit current value to a higher value when decreasing the intensity of the output suppression. Based on the upper limit current value received from the battery control unit 46, the vehicle control unit 30 controls the output current from the inverter 35 to the motor 34. When the output current from the inverter 35 to the motor 34 is limited, the torque of the motor 34 is limited, so that acceleration is suppressed.

The battery control unit 46 can provide setting of the intensity of regenerative charging to the vehicle control unit 30 via the on-board network. In specific, the battery control unit 46 sets ON or OFF of regenerative charging and also sets an upper limit of the charging current from the inverter 35 to the battery module 41 when the regenerative charging is set to ON. When increasing the intensity of the regenerative charging, the battery control unit 46 changes the setting from OFF to ON or changes the upper limit of the charging current to a higher value. When decreasing the intensity of the regenerative charging, the battery control unit 46 changes the setting from ON to OFF or changes the upper limit of the charging current to a lower value. Based on the intensity of the regenerative charging received from the battery control unit 46, the vehicle control unit 30 controls the ratio of regenerative braking to friction braking. When the regenerative charging is set to OFF, the vehicle control unit 30 performs braking only with the friction braking.

FIG. 3 is a diagram that shows an illustrative configuration of the battery temperature control system 1 according to the embodiment. For example, for a battery manufacturer that manufactures the battery pack 40, the battery temperature control system 1 may be built on the battery manufacturer's own server installed at a facility of the battery manufacturer or a data center. Also, the battery temperature control system 1 may be built on a cloud server used based on a cloud service contract. Also, the battery temperature control system 1 may be built on multiple servers distributed and installed at multiple locations (such as data centers and a company's own facilities). Such multiple servers may be any of a combination of a plurality of a company's own servers, a combination of a plurality of cloud servers, and a combination of a company's own server and a cloud server. The battery temperature control system 1 can also perform temperature control of the battery pack 40 of another company.

The battery temperature control system 1 includes a processing unit 11, a storage unit 12, and a communication unit 13. The communication unit 13 is a communication interface (e.g., NIC: Network Interface Card) for connecting to the network 2 by wired or wireless means.

The processing unit 11 includes a battery temperature acquirer 111, an SOC acquirer 112, a position information acquirer 113, a vehicle speed information acquirer 114, a charging schedule information acquirer 115, a target temperature determination unit 116, a set value determination unit 117, and a set value notification unit 118. The functions of the processing unit 11 can be implemented by cooperation between hardware resources and software resources or only by hardware resources. As the hardware resources, CPUs, ROMS, RAMS, GPUs (Graphics Processing Units), ASICs (Application Specific Integrated Circuits), FPGAs (Field Programmable Gate Arrays), and other LSIs can be used. As the software resources, programs, such as operating system programs and application programs, can be employed.

The storage unit 12 includes a non-volatile recording medium, such as an HDD or SSD, and stores various programs and data. The storage unit 12 includes a charge degradation characteristic map 121. The charge degradation characteristic map 121 is a map of the charge cycle degradation rate characteristics of the cells included in the battery pack 40 installed in the electric vehicle 3. The charge cycle degradation rate characteristics of the cells are derived in advance for each type of cell through experiments and simulations performed by the battery manufacturer.

The charge cycle degradation is degradation that progresses as the number of times of charging increases. The charge cycle degradation occurs mainly due to cracking or peeling off caused by expansion or contraction of the active material. The charge cycle degradation depends on the charge rate, use range of SOC, and temperature. In general, the higher the charge rate, the wider the use range of SOC, or the higher the temperature, the higher the charge cycle degradation rate.

The battery temperature acquirer 111 acquires, from the electric vehicle 3 via the network 2, the current battery temperature measured by a temperature sensor provided in the battery module 41. The SOC acquirer 112 acquires the current SOC of the battery module 41 from the electric vehicle 3 via the network 2. The position information acquirer 113 acquires the position information (latitude and longitude) of the electric vehicle 3, from the electric vehicle 3 via the network 2. The vehicle speed information acquirer 114 acquires the vehicle speed information of the electric vehicle 3, from the electric vehicle 3 via the network 2.

The charging schedule information acquirer 115 acquires charging schedule information from the electric vehicle 3 via the network 2. The charging schedule information includes selection information for the charger 4 selected from at least one charger candidate and a desired charging time for the selected charger 4, input to the terminal device 39 by the user.

FIGS. 4A-4B are diagrams that each show an example of a GUI used to set a charging location and a charging time. When the user inputs a destination to a navigation screen displayed on the touch panel display of the terminal device 39, the terminal device 39 searches for a driving route from the current location measured by the GPS sensor 37 to the input destination and displays at least one driving route candidate found in the search on the touch panel display. When the user selects a desired driving route candidate, the driving route is determined.

After the driving route is determined, when the user selects a search for a charging station, the terminal device 39 searches for a charging station located on the determined driving route. The terminal device 39 displays, on a touch panel screen 39a, at least one charging station candidate found in the search and an estimated arrival time at each charging station candidate.

Based on the distance from the current location to each charging station, the electricity consumption of the electric vehicle 3, and the current SOC of the battery module 41, the terminal device 39 determines whether or not each charging station can be reached with the current SOC and only displays, as a selectable candidate, a charging station located at a reachable distance. The terminal device 39 calculates the estimated arrival time at each charging station based on the current time, the distance from the current location to each charging station, and a set average vehicle speed (e.g., 30 km/h on general roads, 50 km/h on suburban roads, and 80 km/h on expressways). In the example shown in FIG. 4A, a charging station A and a charging station B are displayed as the selectable candidates, and the estimated arrival time at the charging station A and the estimated arrival time at the charging station B are displayed. The user selects a desired charging station.

When the charging station B is tapped by the user on the touch panel screen 39a shown in FIG. 4A, the screen switches to the touch panel screen 39a shown in FIG. 4B. The terminal device 39 displays a selectable candidate for the charging time on the touch panel screen 39a. On the touch panel screen 39a shown in FIG. 4B, 30 minutes, 60 minutes, 90 minutes, and 120 minutes are displayed as the selectable candidates for the charging time. The user selects a desired charging time. Alternatively, a GUI may be employed that allows the user to enter a number for the desired charging time. Thus, the user can easily input the desired charging station and charging time.

The description now returns to FIG. 3. The target temperature determination unit 116 determines the target temperature of the battery module 41 at the time of arrival at a charging station to which the electric vehicle 3 is to head. The target temperature may be a fixed value (e.g., 25 degrees C.) or may be set lower (e.g., 20 degrees C.) considering the temperature rise during charging.

The target temperature determination unit 116 may determine the target temperature in more detail considering various conditions. For example, the target temperature determination unit 116 determines a charge rate based on estimated SOC of the battery module 41 at the time of arrival at the charging station and the desired charging time described above. The target temperature determination unit 116 applies the charge rate thus determined and the estimated SOC to the charge degradation characteristic map 121, so as to determine the temperature with the smallest degree of degradation as the target temperature.

Based on the distance from the current location to a charging station as the destination, the electricity consumption of the electric vehicle 3, and the current SOC of the battery module 41, the target temperature determination unit 116 calculates the estimated SOC of the battery module 41 at the time of arrival at the charging station. The target temperature determination unit 116 then calculates the charge rate based on the estimated SOC, charging target SOC, and the desired charging time. For the charging target SOC, a preset fixed value (e.g., 90%, 100%) may be used. Also, it may be configured such that, when the user inputs the desired charging time on the touch panel screen 39a, the charging target SOC can also be input.

FIG. 5 is a diagram that shows a specific example of the charge degradation characteristic map 121. The charge degradation characteristic map 121 shown in FIG. 5 is a two-dimensional map that defines the degree of degradation for each combination of the SOC and charge rate for each temperature. The degree of degradation is defined by a charge degradation rate [%/√Ah], and a smaller value thereof indicates that the progress of degradation is slower. In general, it is known that charge degradation progresses in proportion to ampere-hours (Ah) to the power of 0.5.

For the charge degradation characteristic map 121, a two-dimensional map that defines the degree of degradation for each combination of the temperature and charge rate for each SOC may be used, or a three-dimensional map that defines the degree of degradation for each combination of the temperature, SOC, and charge rate may be used.

For the sake of simplicity, an example in which the charge rate is determined only based on the desired charging time will be considered. The target temperature determination unit 116 sets the charge rate to 1 C when the desired charging time is 60 minutes, to 0.75 C when it is 90 minutes, and to 0.5 C when it is 120 minutes. The target temperature determination unit 116 refers to the charge degradation characteristic map 121 and sets the temperature with the smallest degree of degradation as the target temperature based on the charge rate and the estimated SOC at the time of arrival at the charging station. When the user selects 120 minutes as the desired charging time, the charge rate is 0.5 C. When the estimated SOC at the time of arrival at the charging station is 23%, the degree of degradation at the temperature of 20 degrees C. is the lowest in the charge degradation characteristic map 121 shown in FIG. 5. Accordingly, the target temperature determination unit 116 sets the target temperature to 20 degrees C.

When the charging station is changed by the user during driving, the target temperature determination unit 116 calculates the estimated SOC of the battery module 41 at the time of arrival at the charging station thus changed, based on the distance from the current position of the electric vehicle 3 to the charging station thus changed, the electricity consumption of the electric vehicle 3, and the current SOC of the battery module 41. The target temperature determination unit 116 applies, to the charge degradation characteristic map 121, the estimated SOC of the battery module 41 at the time of arrival at the changed charging station and the charge rate based on the desired charging time newly input, so as to determine the temperature with the smallest degree of degradation as the target temperature.

The description now returns to FIG. 3. The set value determination unit 117 determines a combination of a set value for the regenerative charging, a set value for the output suppression, and a set value for the temperature adjustment unit 47 so that the battery temperature becomes closer to the target temperature. For the battery temperature, any of an average temperature, the maximum temperature, or the minimum temperature of multiple temperatures detected by multiple temperature sensors provided in the battery module 41 may be used. For example, when the standard deviation of the multiple temperatures is less than a set value, the set value determination unit 117 uses an average temperature. When the standard deviation of the multiple temperatures is greater than or equal to the set value and when the battery temperature is higher than the target temperature, the set value determination unit 117 uses the maximum temperature. When the standard deviation of the multiple temperatures is greater than or equal to the set value and when the battery temperature is lower than the target temperature, the set value determination unit 117 uses the minimum temperature.

The set value determination unit 117 controls the battery temperature by coordinating the control of the regenerative charging, output suppression, and temperature adjustment unit 47 so that the battery temperature at the time of arrival at the charging station becomes closer to the target temperature. The set value determination unit 117 monitors the battery temperature while the electric vehicle 3 is driving and adaptively switches each of the set values for the regenerative charging, output suppression, and temperature adjustment unit 47 so that the battery temperature becomes closer to the target temperature quickly.

In the switching of setting, the priority is higher in the order of control of the regenerative charging, output suppression, and temperature adjustment unit 47. In specific, when performing control to lower the temperature of the battery module 41, the set value determination unit 117 sets the setting change of decreasing the intensity of the regenerative charging to the highest priority process, sets the setting change of increasing the intensity of the output suppression to the next highest priority process, and sets the setting change of increasing the cooling intensity of the temperature adjustment unit 47 to the lowest priority process.

As described previously, when the intensity of the output suppression is increased, the torque of the motor 34 is limited, so that acceleration is suppressed and drivability is reduced. The regenerative charging has less influence on drivability and increases the capacity of the battery module 41, so that a higher priority is given thereto. Also, when the cooling intensity of the temperature adjustment unit 47 is increased, the power consumption of the temperature adjustment unit 47 is increased, and the capacity of the battery module 41 is decreased. Therefore, the control of temperature adjustment unit 47 is given a lower priority. It is preferable to stop the temperature adjustment unit 47 as much as possible.

At the time of departure, the set value determination unit 117 determines a combination of the set value for the regenerative charging, the set value for the output suppression, and the set value for the temperature adjustment unit 47, based on the relationship between the current battery temperature and the target temperature. The time of departure may be the point in time when the user determines the charging station.

The set value notification unit 118 transmits, to the vehicle control unit 30 via the network 2, the set value for the regenerative charging, the set value for the output suppression, and the set value for the temperature adjustment unit 47 determined by the set value determination unit 117. According to the set value for the regenerative charging thus received, the vehicle control unit 30 controls the ratio of regenerative braking to friction braking. Also, according to the set value for the output suppression thus received, the vehicle control unit 30 controls the upper limit current of the inverter 35 during driving. The vehicle control unit 30 transmits the set value for the temperature adjustment unit 47 thus received to the battery control unit 46 via the on-board network. Based on the set value for the temperature adjustment unit 47 thus received, the battery control unit 46 controls the temperature adjustment unit 47.

FIG. 6 is a diagram that shows a specific example of a control map that defines control patterns for the regenerative charging, output suppression, and temperature adjustment unit 47, at the time of departure. The example shown in FIG. 6 shows an example in which the target temperature is set to 25 degrees C. When the current battery temperature is 40 degrees C. or higher, the difference from the target temperature is large in the positive direction, so that the set value determination unit 117 sets the intensity of the regenerative charging to “STOP”, the intensity of the output suppression to “STRONG”, and the intensity of the temperature adjustment unit 47 to “STRONG COOLING”. When the current battery temperature is 30 to 40 degrees C., the difference from the target temperature is moderate in the positive direction, so that the set value determination unit 117 sets the intensity of the regenerative charging to “SUPPRESSED”, the intensity of the output suppression to “STRONG”, and the intensity of the temperature adjustment unit 47 to “STRONG COOLING”. The “SUPPRESSED” of the regenerative charging means control that allows the regenerative charging but suppresses the upper limit of the charging current to a lower value.

When the current battery temperature is 20 to 30 degrees C., the difference from the target temperature is small, so that the set value determination unit 117 sets the intensity of the regenerative charging to “SUPPRESSED”, the intensity of the output suppression to “NORMAL”, and the intensity of the temperature adjustment unit 47 to “WEAK COOLING”. The “NORMAL” means the default setting. When the current battery temperature is 10 to 20 degrees C., the difference from the target temperature is moderate in the negative direction, so that the set value determination unit 117 sets the intensity of the regenerative charging to “NORMAL”, the intensity of the output suppression to “NORMAL”, and the intensity of the temperature adjustment unit 47 to “STOP”. When the current battery temperature is 0 to 10 degrees C., the difference from the target temperature is small in the negative direction, so that the set value determination unit 117 sets the intensity of the regenerative charging to “NORMAL”, the intensity of the output suppression to “NORMAL”, and the intensity of the temperature adjustment unit 47 to “STOP”. The intensity of the temperature adjustment unit 47 may also be set to “HEATING”.

The output current during driving or the regenerative current during deceleration is a source of heat generation, and the amount of heat generated increases as the output current during driving or the regenerative current during deceleration increases. Therefore, when the influence of environmental factors such as the outside temperature is ignored, even when the temperature adjustment unit 47 is stopped, the battery temperature rises due to the output current during driving or the regenerative current during deceleration.

When the current battery temperature is lower than 0 degrees C., the set value determination unit 117 sets the intensity of the regenerative charging to “NORMAL”, the intensity of the output suppression to “NORMAL”, and the intensity of the temperature adjustment unit 47 to “HEATING”. Heating is desired because, if the battery temperature remains lower than 0 degrees C. for a long time, storage degradation will progress.

The temperature classification in the control map shown in FIG. 6 is centered on the target temperature=25 degrees C. When the target temperature is changed, the temperature classification is also changed to be centered on the target temperature.

While the electric vehicle 3 is driving, the set value determination unit 117 adaptively switches the combination of the set value for the regenerative charging, the set value for the output suppression, and the set value for the temperature adjustment unit 47, based on the difference between the battery temperature and the target temperature and the changing direction of the difference. More specifically, while the electric vehicle 3 is driving, the set value determination unit 117 judges whether the battery temperature is getting farther from the target temperature or getting closer to the target temperature, based on the transition of the battery temperature, and determines whether to continue or switch the current control pattern in order to bring the battery temperature closer to the target temperature quickly.

The set value determination unit 117 periodically determines whether to continue or switch the control pattern. The determination period does not need to coincide with the battery data acquisition period and may be longer than the battery data acquisition period (e.g., a period of 10 minutes). The set value determination unit 117 may determine whether to continue or switch the control pattern at timing when a predetermined condition is satisfied. For example, it may be determined at timing when the amount of change in battery temperature becomes greater than or equal to a predetermined value.

The set value determination unit 117 can judge whether the difference between the battery temperature and the target temperature is decreasing or increasing, based on the relationship between the difference between the battery temperature and the target temperature at the time of the previous judgment and the difference between the battery temperature and the target temperature in this judgment.

FIG. 7 is a diagram that shows a specific example of a control map that defines control patterns for the regenerative charging, output suppression, and temperature adjustment unit 47, during driving. When the current battery temperature is higher than the target temperature and is getting farther from the target temperature, the set value determination unit 117 sets the intensity of the regenerative charging to “STOP”, increases the intensity of the output suppression, and increases the cooling intensity of the temperature adjustment unit 47 (control pattern 1). When the current battery temperature is higher than the target temperature and is getting closer to the target temperature, the set value determination unit 117 sets the intensity of the regenerative charging to “SUPPRESSED”, sets the intensity of the output suppression to “NORMAL”, and maintains the cooling intensity of the temperature adjustment unit 47 (control pattern 2).

When the current battery temperature is higher than the target temperature, the difference between the current battery temperature and the target temperature has been almost unchanged, and the difference between the current battery temperature and the target temperature is greater than a predetermined value, the set value determination unit 117 sets the intensity of the regenerative charging to “NORMAL”, sets the intensity of the output suppression to “NORMAL”, and increases the cooling intensity of the temperature adjustment unit 47 (control pattern 3). When the current battery temperature is higher than the target temperature, the difference between the current battery temperature and the target temperature has been almost unchanged, and the difference between the current battery temperature and the target temperature is smaller than the predetermined value, the set value determination unit 117 sets the intensity of the regenerative charging to “NORMAL”, sets the intensity of the output suppression to “NORMAL”, and maintains the cooling intensity of the temperature adjustment unit 47 (control pattern 4). The control patterns 1 to 4 are control patterns for the case when the battery module 41 needs cooling.

When the current battery temperature is lower than the target temperature, the current battery temperature is getting farther from the target temperature, and the difference between the current battery temperature and the target temperature is greater than the predetermined value, the set value determination unit 117 sets the intensity of the regenerative charging to “NORMAL”, sets the intensity of the output suppression to “NORMAL”, and sets the intensity of the temperature adjustment unit 47 to “HEATING” (control pattern 5). When the current battery temperature is lower than the target temperature, the current battery temperature is getting farther from the target temperature, and the difference between the current battery temperature and the target temperature is smaller than the predetermined value, the set value determination unit 117 sets the intensity of the regenerative charging to “NORMAL”, sets the intensity of the output suppression to “NORMAL”, and sets the intensity of the temperature adjustment unit 47 to “STOP” (control pattern 6). When the current battery temperature is lower than the target temperature and is getting closer to the target temperature, the set value determination unit 117 sets the intensity of the regenerative charging to “NORMAL”, sets the intensity of the output suppression to “NORMAL”, and maintains the intensity of the temperature adjustment unit 47 (control pattern 7).

When the current battery temperature is lower than the target temperature, the difference between the current battery temperature and the target temperature has been almost unchanged, and the difference between the current battery temperature and the target temperature is greater than the predetermined value, the set value determination unit 117 sets the intensity of the regenerative charging to “NORMAL”, sets the intensity of the output suppression to “NORMAL”, and sets the intensity of the temperature adjustment unit 47 to “HEATING” (control pattern 8). When the current battery temperature is lower than the target temperature, the difference between the current battery temperature and the target temperature has been almost unchanged, and the difference between the current battery temperature and the target temperature is smaller than the predetermined value, the set value determination unit 117 sets the intensity of the regenerative charging to “NORMAL”, sets the intensity of the output suppression to “NORMAL”, and sets the intensity of the temperature adjustment unit 47 to “STOP” (control pattern 9). The control patterns 5 to 9 are control patterns for the case when the battery module 41 needs heating.

When the current battery temperature and the target temperature are substantially equal, the set value determination unit 117 maintains the intensity of the regenerative charging, maintains the intensity of the output suppression, and maintains the intensity of the temperature adjustment unit 47 (control pattern 10). The control pattern 10 is a pattern that does not require switching.

FIG. 8 is a diagram that shows a specific example of control pattern switching during driving. In an early stage of FIG. 8, the battery temperature is higher than the target temperature and is getting farther from the target temperature, so that the set value determination unit 117 sets the intensity of the regenerative charging to “STOP”, increases the intensity of the output suppression, and increases the cooling intensity of the temperature adjustment unit 47 (control pattern 1). When the battery temperature gets closer to the target temperature, the set value determination unit 117 changes the intensity of the regenerative charging to “SUPPRESSED”, changes the intensity of the output suppression to “NORMAL”, and maintains the cooling intensity of the temperature adjustment unit 47 (control pattern 2). That is, the control pattern is switched from the control pattern 1 to the control pattern 2. When the battery temperature falls below the target temperature, the set value determination unit 117 changes the intensity of the regenerative charging to “NORMAL”, sets the intensity of the output suppression to “NORMAL”, and changes the intensity of the temperature adjustment unit 47 to “STOP” (control pattern 6). That is, the control pattern is switched from the control pattern 2 to the control pattern 6. When the difference between the battery temperature and the target temperature is greater than the predetermined value and when the difference between the battery temperature and the target temperature continues to be almost unchanged, the set value determination unit 117 sets the intensity of the regenerative charging to “NORMAL”, sets the intensity of the output suppression to “NORMAL”, and changes the intensity of the temperature adjustment unit 47 to “HEATING” (control pattern 8). This allows the battery temperature to rise toward the target temperature.

The set value determination unit 117 may change at least one of the set value for the regenerative charging, the set value for the output suppression, or the set value for the temperature adjustment unit 47, according to at least one of the distance between the current position of the electric vehicle 3 and the charging station, or the current SOC. More specifically, when the set value determination unit 117 judges, based on the distance from the current position of the electric vehicle 3 to the charging station, the electricity consumption of the electric vehicle 3, and the current SOC of the battery module 41, that it may be unable to reach the charging station, the set value determination unit 117 performs at least one of increasing the intensity of the regenerative charging or decreasing the cooling intensity or heating intensity of the temperature adjustment unit 47. Either of these setting changes acts to suppress the decrease in SOC of the battery module 41. When there is a margin of SOC sufficient to reach the charging station, the set value determination unit 117 may perform at least one of decreasing the intensity of the regenerative charging or increasing the cooling intensity or heating intensity of the temperature adjustment unit 47.

Based on an estimated temperature of the battery module 41 at a point that precedes the charging station by a predetermined distance and speed information of the electric vehicle 3, the set value determination unit 117 may perform control to increase the intensity of the temperature adjustment unit 47 at the point.

The set value determination unit 117 estimates the battery temperature at an arbitrary point before the charging station (a point preceding the charging station by n [km]).Based on the distance from the current position of the electric vehicle 3 to the point preceding the charging station by n [km] and the speed information of the electric vehicle 3, the set value determination unit 117 estimates the travel time to the point preceding the charging station by n [km]. As the speed information of the electric vehicle 3, an average speed from the departure of the electric vehicle 3 may be used, or a preset average speed (e.g., 30 km/h on general roads, 50 km/h on suburban roads, and 80 km/h on expressways) may be used.

Based on the estimated travel time, the current battery temperature, and the latest change rate (slope) of the battery temperature, the set value determination unit 117 estimates the battery temperature at the point preceding the charging station by n [km]. The set value determination unit 117 can generate the latest change rate of the battery temperature by, for example, performing linear regression on multiple battery temperatures measured most recently. As the simplest process, the set value determination unit 117 may use the difference between the current battery temperature and the battery temperature a predetermined time earlier (e.g., 10 minutes earlier), as the latest change rate of the battery temperature.

In the following, it is assumed that the temperature control capability per unit time of the temperature adjustment unit 47 is t [degrees C./h], a predicted value of the battery temperature at the point preceding the charging station by n [km] is m [degrees C.], and the average speed of the electric vehicle 3 is s [km/h]. Based on the distance n [km] to the charging station and the average speed s [km/h] of the electric vehicle 3, the set value determination unit 117 obtains the travel time n/s [h] to the charging station. Based on the travel time n/s [h] to the charging station and the temperature control capability per unit time t [degrees C./h] of the temperature adjustment unit 47, the set value determination unit 117 calculates a controllable temperature Tn [degrees C.] that can be controlled until the charging station. The set value determination unit 117 also calculates a difference temperature ΔTn between the predicted value m [degrees C.] of the battery temperature at the point preceding the charging station by n [km] and the target temperature.

The set value determination unit 117 compares the difference between the controllable temperature Tn [degrees C.] and the difference temperature ΔTn with a predetermined threshold. When the difference between the controllable temperature Tn [degrees C.] and the difference temperature ΔTn is within the predetermined threshold, the set value determination unit 117 maintains the intensity of the temperature adjustment unit 47. When the difference between the controllable temperature Tn [degrees C.] and the difference temperature ΔTn exceeds the predetermined threshold, the set value determination unit 117 sets the intensity of the temperature adjustment unit 47 to “STOP” until the point preceding the charging station by n [km] and then increases the intensity of the temperature adjustment unit 47 at the point preceding the charging station by n [km]. At the time, the set value determination unit 117 increases the intensity of the temperature adjustment unit 47 within a range in which the electric vehicle 3 can reach the charging station, based on the distance n [km] to the charging station, the estimated SOC [%] of the battery module 41 at the point preceding the charging station by n [km], and the electricity consumption of the electric vehicle 3.

By adding this process, the temperature adjustment unit 47 can be stopped as much as possible until an arbitrary point before the charging station, and the battery temperature can be controlled while suppressing the power consumption. This process may be applied only when the difference between the battery temperature at the time of departure and the target temperature is small or may be applied only when the vehicle is driving without the temperature control by the temperature adjustment unit 47.

When the battery temperature at the time of arrival at the charging station is higher than the target temperature, the set value determination unit 117 increases the cooling intensity of the temperature adjustment unit 47. For example, the set value determination unit 117 increases the cooling intensity of the temperature adjustment unit 47 to the maximum to rapidly cool the battery module 41.

FIG. 9 is a flowchart that shows an outline of setting processing for the regenerative charging, output suppression, and temperature adjustment unit 47 before departure. The terminal device 39 displays at least one charging station candidate on the display (S10). The charging schedule information acquirer 115 acquires the charging station and the desired charging time selected by the user (S11). The battery temperature acquirer 111 acquires the battery temperature (S12). The set value determination unit 117 calculates the difference between the battery temperature and the target temperature (S13) and determines the set value for the regenerative charging, the set value for the output suppression, and the set value for the temperature adjustment unit 47 based on the difference (S14). The set value notification unit 118 transmits the set value for the regenerative charging, the set value for the output suppression, and the set value for the temperature adjustment unit 47 to the vehicle control unit 30 via the network 2 (S15).

FIG. 10 is a flowchart that shows an outline of setting processing for the regenerative charging, output suppression, and temperature adjustment unit 47 during driving. The battery temperature acquirer 111 acquires the battery temperature (S20). The set value determination unit 117 calculates the difference between the battery temperature and the target temperature (S21) and identifies the changing direction of the difference (S22). Based on the difference and the changing direction of the difference, the set value determination unit 117 judges whether or not the switching of the control pattern is necessary (S23). When the set value determination unit 117 judges that the switching of the control pattern is necessary (Y at S23), the set value determination unit 117 changes at least one of the set value for the regenerative charging, the set value for the output suppression, or the set value for the temperature adjustment unit 47, based on the difference and the changing direction of the difference (S24). The set value notification unit 118 transmits the set value for the regenerative charging, the set value for the output suppression, and the set value for the temperature adjustment unit 47, of which at least one has been changed, to the vehicle control unit 30 via the network 2 (S25). When it is judged that the switching of the control pattern is unnecessary (N at S23), the processes of steps S24 and S25 are skipped.

As described above, according to the present embodiment, the battery temperature can be efficiently adjusted to the target temperature by the time of arrival at a charging station, and efficient charging with less degradation can be performed within a desired charging time at the charging station after the arrival. Since the loss of charging time can be reduced, an increase in transportation time and a decrease in convenience can be avoided. Also, by determining the target temperature according to the charge rate based on the desired charging time and the estimated SOC at the time of arrival at the charging station, the degradation of the battery module 41 due to charging can be minimized.

The present disclosure has been described with reference to an embodiment. The embodiment is intended to be illustrative only, and it will be obvious to those skilled in the art that various modifications to a combination of constituting elements or processes could be developed and that such modifications also fall within the scope of the present disclosure.

The aforementioned embodiment describes an example in which the battery temperature control system 1 is built on a company's own server set in a facility of the company or a data center or on a cloud server. In this regard, the battery temperature control system 1 may be incorporated into the battery control unit 46 or the vehicle control unit 30. In such a case, the wireless communication unit 38 may be omitted.

In the aforementioned embodiment, a four-wheeled electric automobile is assumed as the electric vehicle 3. In this regard, an electric motorcycle (electric scooter) or an electric bicycle may also be used. Also, the electric automobiles include not only full-standard electric automobiles but also low-speed electric automobiles, such as golf carts, and land cars used in shopping malls and entertainment facilities.

The embodiment may be defined by the following Items.

### [Item 1]

A battery temperature control system (1), including:
a battery temperature acquirer (111) that acquires a measured battery temperature of a battery module (41) in a battery pack (40) installed in an electric vehicle (3), the battery pack (40) including the battery module (41), a temperature adjustment unit (47) that adjusts the temperature of the battery module (41), and a battery control unit (46) that outputs a set value for regenerative charging and a set value for output suppression to a vehicle control unit (30) that controls an inverter (35) connected between the battery module (41) and a motor (34) for driving;
a target temperature determination unit (116) that determines a target temperature of the battery module (41) at the time of arrival at an installation place of a charger (4) to which the electric vehicle (3) is to head; and
a set value determination unit (117) that determines a combination of a set value for the regenerative charging, a set value for the output suppression, and a set value for the temperature adjustment unit (47) such that the battery temperature becomes closer to the target temperature.

According to this, the battery temperature can be efficiently adjusted to the target temperature by the time of arrival at the installation place of the charger (4).

### [Item 2]

The battery temperature control system (1) according to Item 1, wherein, when performing control to lower the battery temperature, the set value determination unit (117) sets a setting change of decreasing the intensity of the regenerative charging to the highest priority process, sets a setting change of increasing the intensity of the output suppression to the next highest priority process, and sets a setting change of increasing the cooling intensity of the temperature adjustment unit (47) to the lowest priority process.

According to this, reduction in drivability and reduction in capacity of the battery module (41) can be minimized.

### [Item 3]

The battery temperature control system (1) according to Item 1 or 2, wherein, while the electric vehicle (3) is driving, the set value determination unit (117) adaptively switches the combination of the set value for the regenerative charging, the set value for the output suppression, and the set value for the temperature adjustment unit (47), based on a difference between the battery temperature and the target temperature, and the changing direction of the difference.

According to this, the battery temperature can be brought closer to the target temperature as quickly as possible.

### [Item 4]

The battery temperature control system (1) according to any one of Items 1 through 3, wherein the set value determination unit (117) changes at least one of the set value for the regenerative charging, the set value for the output suppression, or the set value for the temperature adjustment unit (47), according to at least one of the distance between the current position of the electric vehicle (3) and the installation place of the charger (4), or the current SOC (State Of Charge).

According to this, the risk of not reaching the installation place of the charger (4) can be avoided.

### [Item 5]

The battery temperature control system (1) according to any one of Items 1 through 4, wherein, based on an estimated temperature of the battery module (41) at a point that precedes the installation place of the charger (4) by a predetermined distance and speed information of the electric vehicle (3), the set value determination unit (117) performs control to increase the intensity of the temperature adjustment unit (47) at the point.

According to this, the temperature adjustment unit (47) can be stopped as much as possible, and the reduction in capacity of the battery module (41) can be minimized as much as possible.

### [Item 6]

The battery temperature control system (1) according to any one of Items 1 through 5, further including a charging schedule information acquirer (115) that acquires charging schedule information including selection information for a charger (4) selected from at least one charger (4) candidate and a desired charging time for the selected charger (4), input to a terminal device by a user.

According to this, usability can be enhanced.

### [Item 7]

The battery temperature control system (1) according to Item 6, wherein the target temperature determination unit (116) applies, to charge degradation characteristics of the battery module (41), estimated SOC (State Of Charge) of the battery module (41) at the time of arrival at the installation place of the charger (4) and a charge rate determined based on at least the desired charging time, so as to determine the target temperature.

According to this, the degradation of the battery module (41) due to charging can be minimized.

### [Item 8]

The battery temperature control system (1) according to any one of Items 1 through 7, wherein, when the battery temperature at the time of arrival at the installation place of the charger (4) is higher than the target temperature, the set value determination unit (117) increases the cooling intensity of the temperature adjustment unit (47).

According to this, the degradation of the battery module (41) due to charging can be minimized as much as possible.

### [Item 9]

A battery temperature control method, including:
acquiring a measured battery temperature of a battery module (41) in a battery pack (40) installed in an electric vehicle (3), the battery pack (40) including the battery module (41), a temperature adjustment unit (47) that adjusts the temperature of the battery module (41), and a battery control unit (46) that outputs a set value for regenerative charging and a set value for output suppression to a vehicle control unit (30) that controls an inverter (35) connected between the battery module (41) and a motor (34) for driving;
determining a target temperature of the battery module (41) at the time of arrival at an installation place of a charger (4) to which the electric vehicle (3) is to head; and
determining a combination of a set value for the regenerative charging, a set value for the output suppression, and a set value for the temperature adjustment unit (47) such that the battery temperature becomes closer to the target temperature.

According to this, the battery temperature can be efficiently adjusted to the target temperature by the time of arrival at the installation place of the charger (4).

### [Item 10]

A battery temperature control program causing a computer to implement:
a module that acquires a measured battery temperature of a battery module (41) in a battery pack (40) installed in an electric vehicle (3), the battery pack (40) including the battery module (41), a temperature adjustment unit (47) that adjusts the temperature of the battery module (41), and a battery control unit (46) that outputs a set value for regenerative charging and a set value for output suppression to a vehicle control unit (30) that controls an inverter (35) connected between the battery module (41) and a motor (34) for driving;
a module that determines a target temperature of the battery module (41) at the time of arrival at an installation place of a charger (4) to which the electric vehicle (3) is to head; and
a module that determines a combination of a set value for the regenerative charging, a set value for the output suppression, and a set value for the temperature adjustment unit (47) such that the battery temperature becomes closer to the target temperature.

According to this, the battery temperature can be efficiently adjusted to the target temperature by the time of arrival at the installation place of the charger (4).

1. A battery temperature control system, comprising:
a battery temperature acquirer that acquires a measured battery temperature of a battery module in a battery pack installed in an electric vehicle, the battery pack comprising the battery module, a temperature adjustment unit that adjusts the temperature of the battery module, and a battery control unit that outputs a set value for regenerative charging and a set value for output suppression to a vehicle control unit that controls an inverter connected between the battery module and a motor for driving;
a target temperature determination unit that determines a target temperature of the battery module at the time of arrival at an installation place of a charger to which the electric vehicle is to head; and
a set value determination unit that determines a combination of a set value for the regenerative charging, a set value for the output suppression, and a set value for the temperature adjustment unit such that the battery temperature becomes closer to the target temperature.

2. The battery temperature control system according to claim 1, wherein, when performing control to lower the battery temperature, the set value determination unit sets a setting change of decreasing the intensity of the regenerative charging to the highest priority process, sets a setting change of increasing the intensity of the output suppression to the next highest priority process, and sets a setting change of increasing the cooling intensity of the temperature adjustment unit to the lowest priority process.

3. The battery temperature control system according to claim 1, wherein, while the electric vehicle is driving, the set value determination unit adaptively switches the combination of the set value for the regenerative charging, the set value for the output suppression, and the set value for the temperature adjustment unit, based on a difference between the battery temperature and the target temperature, and the changing direction of the difference.

4. The battery temperature control system according to claim 1, wherein the set value determination unit changes at least one of the set value for the regenerative charging, the set value for the output suppression, or the set value for the temperature adjustment unit, according to at least one of the distance between the current position of the electric vehicle and the installation place of the charger, or the current SOC (State Of Charge).

5. The battery temperature control system according to claim 1, wherein, based on an estimated temperature of the battery module at a point that precedes the installation place of the charger by a predetermined distance and speed information of the electric vehicle, the set value determination unit performs control to increase the intensity of the temperature adjustment unit at the point.

6. The battery temperature control system according to claim 1, further comprising a charging schedule information acquirer that acquires charging schedule information including selection information for a charger selected from at least one charger candidate and a desired charging time for the selected charger, input to a terminal device by a user.

7. The battery temperature control system according to claim 6, wherein the target temperature determination unit applies, to charge degradation characteristics of the battery module, estimated SOC (State Of Charge) of the battery module at the time of arrival at the installation place of the charger and a charge rate determined based on at least the desired charging time, so as to determine the target temperature.

8. The battery temperature control system according to claim 1, wherein, when the battery temperature at the time of arrival at the installation place of the charger is higher than the target temperature, the set value determination unit increases the cooling intensity of the temperature adjustment unit.

9. A battery temperature control method, comprising:
acquiring a measured battery temperature of a battery module in a battery pack installed in an electric vehicle, the battery pack comprising the battery module, a temperature adjustment unit that adjusts the temperature of the battery module, and a battery control unit that outputs a set value for regenerative charging and a set value for output suppression to a vehicle control unit that controls an inverter connected between the battery module and a motor for driving;
determining a target temperature of the battery module at the time of arrival at an installation place of a charger to which the electric vehicle is to head; and
determining a combination of a set value for the regenerative charging, a set value for the output suppression, and a set value for the temperature adjustment unit such that the battery temperature becomes closer to the target temperature.

10. A non-transitory computer-readable recording medium having embodied thereon battery temperature control program causing a computer to implement:
a module that acquires a measured battery temperature of a battery module in a battery pack installed in an electric vehicle, the battery pack comprising the battery module, a temperature adjustment unit that adjusts the temperature of the battery module, and a battery control unit that outputs a set value for regenerative charging and a set value for output suppression to a vehicle control unit that controls an inverter connected between the battery module and a motor for driving;
a module that determines a target temperature of the battery module at the time of arrival at an installation place of a charger to which the electric vehicle is to head; and
a module that determines a combination of a set value for the regenerative charging, a set value for the output suppression, and a set value for the temperature adjustment unit such that the battery temperature becomes closer to the target temperature.
